(19) United States
(12) Patent Application Publication
(10) Pub. No.: US 2016/0002079 A1
(43) Pub. Date: Jan. 7, 2016

(54) IMPROVED FERMENTATION PROCESS AND PRODUCTS USEFUL FOR THE SAME

(71) Applicant: Atul Ambaji NIVARGI, Maharashtra (IN)

(72) Inventor: Atul Ambaji Nivargi, Maharashtra (IN)

(21) Appl. No.: 14/768,447

(22) PCT Filed: Feb. 18, 2014
(86) PCT No.: PCT/IN2014/000099

§ 371 Date: Aug. 17, 2015

(30) Foreign Application Priority Data
Feb. 18, 2013 (IN) 475/MUM/2013

(51) Int. Cl. C02F 3/10; C02F 3/34; C02F 3/02

(52) U.S. Cl. CPC C02F 3/10; C02F 3/02; C02F 3/347; C02F 2203/006

(57) ABSTRACT

The invention comprises a method/process of moving bed fermentation of a liquid carried out by microorganisms in a fermenter/reactor wherein the moving bed comprises a device containing within or on its surface a porous material capable of providing anchorage to bacteria capable of performing fermentation/degradation of organic load and the device is moveable throughout the column of the liquid in the fermenter/reactor when the device is added to the fermenting liquid and the fermenting liquid is agitated/aerated. This device is an artificial device. The method/process of this invention comprises fermentation of raw sewage or any other liquid containing fermentable organic dissolved solids, This invention comprises a device containing within or on its surface a porous material capable of providing anchorage to bacteria capable of performing fermentation/degradation and the device is moveable throughout the column of the liquid in the fermenter/reactor/aeration tank when the device is added to the fermenting liquid and the fermenting liquid is agitated/aerated by blower/aerator or any other means of improving aeration of the liquid. The porous material comprises activated carbon as granules or otherwise. In one embodiment, the device of this invention is impregnated with live bacteria required for the aerobic fermentation.

### TECHNICAL FIELD

The present invention relates generally to fermentation including waste water processing, sewage treatment plants and more particularly to an improved method for processing waste water for domestic and industrial use. The invention also pertains to improved media for supporting anchorage of and growth of biomass of the micro-organisms that purify water by bio degradation.

### BACKGROUND OF THE INVENTION

Demand of water has been continuously rising since past few decades due to the expansion of industry and the growing domestic water consumption. The demand is rising almost at double the rate of population growth during this century.

With increased water need, the quality requirements have also become more and more stringent.

As water becomes more and more scarce, an effective and economical approach to water treatment has become indispensable since availability of water cannot increase and it is feared that it is actually declining with environmental changes.

Fresh Treated water for drinking purpose is not available in sufficient quantity and quality even in urban areas; situation in rural area is worse.

Due to heavy urbanization, load on city water supply for domestic drinking water has become a big Question.

This has made recycling of wastewater an important necessity. However, currently used sewage treatment plants in large cities require heavy expenses in infrastructure, in terms of location requirements, space requirements, capital costs and operational cost.

Major technologies used currently used for recycling of domestic and industrial sewage water includes (A) Aerobic Digestion/Biodegradation, (B) Anaerobic Digestion/Biodegradation, or (C) Combination of both (A) and (B).

Aerobic Digestion Process comprises: (1) Activated Sludge Process, (2) Moving Bed Bio Reactor, (3) Fixed Film Bio Reactor, (4) Sequential Batch Reactor, (5) Membrane Bio Reactor.

The process of recycling is basically based on natural law of conversion cycle i.e. Carbon Cycle, Oxygen cycle, Nitrogen cycle etc. In this process degradation/oxidation of organic/inorganic material is done with the help of bacterial colonies The organic load get decomposed to gases, water and earth element.

Conventional method of Activated sludge process, which is in widespread use for recycling of waste-water, has its process limitations. The process requires considerably big space, and very high rate of aeration to achieve desired reduction in Chemical Oxygen Demand (COD) and Biological Oxygen Demand (BOD).

Effectiveness of the degradation process is depends on the numbers of bacteria colonies available to degrade the incoming water/sewage/sullage load. For growth of bacteria colonies water is aerated by different methods (with Blower, Mechanical Aerators) to increase dissolved oxygen level in the water.

As the number of colonies of such bacteria increases probability of faster and quicker degradation/reduction in BOD/COD is possible.

There are Different methods being used for sewage treatment.

Some of them are as listed below—

1) Activated Sludge Process—where bacteria colonies get develop on suspended solid mass in the water/sewage. Percentage of the available bacteria colonies is measured in MLSS i.e. “Mixed Liquor Suspended Solids”.

2) In Submerged Activated Fixed Film reactor (SAFF), bacteria develop on fixed film that is submerged in the water.

3) In Trickling Filter (TF) Media, bacteria grow on the filter media bed.

4) In Rotating Bed Reactor (RBC) media, the bacteria grow on rotating Drum Media.

5) Moving Bed Bio Reactor method (MBBR method)—The bacteria colonies develop on the plastic media provided which is in floating condition. Such media are known as “MBBR media” i.e. “Moving Bed Biofilm Reactor media”

In sewage treatment plant, plastic media in the form of flat discs of round or other shapes, are being used in MBBR method to get enhanced surface area of approximately 250 to 400 M²/M³ (square meters of the enhanced surface per cubic meter of the media volume) to a maximum of up to 1200 M²/M³ by using different types of plastic media in different quantities per cubic meter. This surface area provided by these Plastic media is used as area on which the micro-carrying out biodegradation can anchor themselves and grow. Micro-organisms perform better when anchorage is provided to them than when just aeration of their suspension without providing anchorage.

Such media are commercially available. Information of widely used commercially available plastic media is given in Table 1.

TABLE 1
Specific Surface Area for Attached Growth Media

| | Specific |
|---|---|
| | Surface Area |
| | (m2/m3) |
| Trickling Filter Media | |
| Rock | 45-60* |
| Plastic | 90-150* |
| Rotating Biological Contactor | 100-150* |
| MBBR Media | |
| Kaldnes K-1 Media | 500 |
| Hydroxyl Media | 400 |
| Kaldnes Flat Chip | 1200 |

Data from Metcalf and Eddy (2003): Wastewater Engineering: Treatment and Reuse, International Edition, McGraw-Hill, Boston, Massachusetts. In Evaluation of moving bed biofilm reactor technology for enhancing nitrogen removal in a stabilization pond treatment plant; Jeffery S. Weiss*, Marcos Alvarez, Chi-Chung Tang, Robert W. Horvath, and James F. Stahl, Sanitation Districts of Los Angeles County 1955 Workman Mill Rd. Whittier, California 90601; downloaded on Friday, October 19, 2012, 7:01:46 PM--- from internet from link: http://www.environmental-expert.com/Files/384/articles/16315/2.pdf.

Amongst all methods of aerobic biodegradation known so far, MBBR is considered as efficient method and has given best know efficiencies so far in aerobic digestion and plastic media described above have given excellent and highest improvements in efficiencies known so far. Weiss et al (2005) report that “The first MBBR facility became operational in 1990 in Lardnal, Norway. MBBR technology has since made significant penetration into the European market with an installed base of more than 300 MBBR systems.” Thus, since 1990, during last about 22 years, MBBR system is considered as best available system and no further advance has been reported in the aerobic biodegradation of sewage.

With increasing need and requirement of recycling of wastewater, cost of treatment to wastewater for purification has become an important aspect where the re is a need for continuing efforts for improvement in cost efficiency.

### SUMMARY OF THE INVENTION

The invention comprises a method/process of moving bed fermentation, of a liquid carried out by microorganisms in a fermenter/reactor wherein the moving bed comprises a device containing within or on its surface a porous material capable of providing anchorage to bacteria capable of performing fermentation/degradation of organic matter and the device is moveable throughout the column of the liquid in the fermenter/reactor when the device is added to the fermenting liquid and the fermenting liquid is agitated/aerated. This device is an artificial device.

In one embodiment, the method/process is aerobic fermentation of water carried out for reducing Chemical Oxygen Demand (COD) and the microorganisms comprise any one or more selected from the group consisting of bacteria, fungi and other microorganisms capable of carrying out fermentation. and the fermenting liquid is aerated by blower/aerator or by any other means for improving aeration

The method/process of this invention, in one embodiment, comprising the following steps: (a) adding a number of the devices to the water in fermenter/reactor, (b) aerating the water to achieve growth of the microorganisms on the surface of the devices available for anchorage, (c) agitating the liquid in the fermenter by a means for achieving movement of the devices in the fermenter, (d) and allowing the fermentation to proceed for a period of time required to bring down the COD load to 100 ppm (parts per million) or to other target level.

The method/process of this invention comprises fermentation of raw sewage or any other liquid containing fermentable organic dissolved solids,

In another aspect, the device used in this invention comprises a a biodegradation resistant Moving Bed Biofilm Reactor Media (MBBR media) or a biodegradation resistant sachet of a fabric permeable to liquid containing dissolved solids containing within it the porous material and, optionally, float that renders the sachet moveable in the fermenting liquid when agitated,

The porous material comprises any one or more selected from the group consisting of activated carbon as granules or otherwise, saw dust of wood, chips of wood and diskettes of wood the porous material is activated carbon. The means to provide the agitation/aeration is one or more selected from the group bubbling of air through the fermenter, bubbling oxygen of varying purity thorough the fermenter, using the impeller or propeller, up-flow or down-flow of liquid by pumping action or Twin lobe/centrifugal air blower used to increase dissolved oxygen level.

In another aspect, this invention comprises a device containing within or on its surface a porous material capable of providing anchorage to bacteria capable of performing fermentation/degradation and the device is moveable throughout the column of the liquid in the fermenter/reactor/aeration tank when the device is added to the fermenting liquid and the fermenting liquid is agitated/aerated by blower/aerator or any other means of improving aeration of the liquid.

The device comprises any one or all of the following: (a) sachets which are made from a material that is permeable to the liquid in the fermenter, hold the porous material within them, and are: (i) made of a material that has a density that helps to make the sachet movable when the sachets are added to the fermenting liquid in fermenter and the fermenting liquid is agitated, or (ii) are associated with a means for adjusting the density of the sachets such that they become moveable when the sachets are added to the fermenting liquid in the fermenter and the fermenting liquid is agitated; or (b) an article having surface to which the porous material is immobilized on the surface and the article having a density such that they become moveable when they are added to the fermenting liquid in the fermenter and the fermenting liquid is agitated comprising any one or more, without limitation, selected from the group comprising of Moving Bed Biofilm Reactor media, a polymer foam sheet that does not absorb water when immersed in water/fermenting liquid and the like. The material that is permeable to the liquid in the fermenter comprises a fabric/paper made from synthetic polymers or any other material that has reasonably long life and re-usability in the fermenter. The means for adjusting the density of the sachets comprises a material that has a density lower than water, can be retained within the sachet, and has reasonably long life and re-usability in the fermenter.

The porous material with which the device of this invention is made of or is associated with consists of a synthetic material or a natural material. The synthetic material is one or more, without limitation, comprising a polypropylene foam sheet, plastic media/sheet, polypropylene non woven fabric, polypropylene non woven filter paper, polypropylene woven film/paper/sheet having density lower than water, any colour thickness shape any size, any other synthetic article that can be used as a float and the like. The natural material is one or more, without limitation, comprising painted wood pieces, wood diskettes/small discs, wood chips, wooden filings, perlite, vermiculite, any naturally occurring material that can be used as a float and the like.

In one embodiment, the device of this invention is impregnated with live bacteria required for the aerobic fermentation.

### BRIEF DESCRIPTION OF FIGURES AND LEGENDS

FIG. 1: Not drawn to scale.

A1: Top view of sachet/pouch. AL—Length 50 mm, AW—Width 30 mm,

A2: Vertical section of A1 through the thickness along the line A2-A2 in the figure A1.

(A2-1)—upper surface of the upper face of the sachet; A2-2—inner surface of upper surface of the sachet, A2-3—inner surface of the lower face of the sachet; A2-4—lower surface of the lower face of the sachet, A2-5—Activated Carbon granules

B1: Top view of Polypropylene foam sheet.

BL—Length 50 mm; BW—Width 50 mm

B2: Vertical section of B1 through the thickness along the line B2-B2 in the figure B1

B2-6—Activated Carbon granules pasted on upper surface

B2-7 Thickness 2 mm

B2-8—Activated Carbon granules pasted on lower surface

C “Fermenter A” carrying sachets of the instant invention as moving beds. C1—Plastic tank capacity 1000 liters; C2—polymer fabric sachets filled with activated carbon or polypropylene foam sheets with carbon granules pasted on upper and lower surface or any other embodiment of moving bed of this invention; C3—Raw sewage; C4—Air bubbles coming through the air diffuser/sparger/grid; C5—air diffuser/sparger/grid; C6—Air compressor.

D—“Fermenter B” carrying MBBR plastic media available in market having cylindrical shape D1—Plastic tank capacity 1000 liters; D2—MBBR plastic media available in market having cylindrical shape; D3—Raw sewage; D4—Air bubbles coming through the air diffuser/sparger/grid; D5—air diffuser/sparger/grid; D6—Air compressor.

### DETAILED DESCRIPTION OF THE INVENTION

It was surprisingly found that as a support for growth of bacteria, Activated Carbon, was more efficient than even the plastic media in MBBR system for reducing COD in a system of aerobic treatment of waste water containing organic biodegradable pollutants.

In working of this invention, the Activated Carbon may be replaced by other porous media too. Such alternatives may include, without limitation, wood chips, wooden saw dust and the like.

Thus, this invention provides a process of reducing Chemical Oxygen Demand (COD) load by aerobic fermentation of water needing recycling and contains nutrients to support an aerobic microbial growth; wherein a support to the aerobic micro-organisms is provided by a porous medium in the reactor.

An embodiment of this invention of comprises a porous medium providing support for anchorage and growth of bacteria.

In one embodiment, the porous medium may be stationary. In another embodiment, the porous medium may be floating. In still another embodiment, the porous medium may be immobilized on a stationary support.

In still another embodiment of this invention, the porous media are prepared in a form of a product/medium adapted to its use for aerobic biodegradation of sewage.

In yet another embodiment, the waste water treated is domestic sewage. The domestic sewage may be replaced by industrial waste water containing organic and inorganic impurities on which aerobic microorganisms can grow. The waste water may be a processing waste water from an agricultural products processing industry or an animal products processing industry.

In a particular embodiment of this invention, activated carbon is used as a supporting medium for bacterial growth.

In a specific embodiment of this invention, the activated carbon is in the form of Granules of Activated Carbon.

In another embodiment of the invention, the activated carbon used as porous medium for bacterial growth is soaked for a period of time in active bacterial culture capable of aerobic degradation.

This invention also comprises a device, which is an artificial means, by which porous material is caused to associate with it in various ways such that the porous material is available for the microorganisms to anchor on them. The ways of association may include incorporating the porous material within the device or attaching/immobilizing on the surface of the device.

In one embodiment of this invention, the activated carbon comprises granules floating in the water being treated in the reactor. Any modification of the form of Activated Carbon may be used. Thus, in yet another variation of this invention, the activated carbon may be supported/immobilized on various support structures that would improve efficiency of the Activated carbon further in terms of faster reduction of the COD. In one such embodiments, granules of activated carbon were immobilized on the surface of plastic MBBR media. Several adhesives were used. However, the limitation was that it was difficult to automate the process of producing such media for the purpose of producing the plastic MBBR media with activated carbon immobilized on their surface in large enough quantity.

Attempts were made to immobilize activated carbon granules/powder in molten polymer in several different ways. However, surface of the carbon granules available for providing anchorage to bacteria got severely reduced and none of these methods were found useful.

Plastic containers having holes and holding activated carbon granules were also tried; however, after some time such containers sank in the fermenter and were considered unsuitable for the purpose.

Polypropylene Foam sheet of thickness 2 mm of sq sheet 50×50 mm on which activated carbon graduals were stuck with an adhesive did work very well in field trial. However, large scale production of these was seen to be difficult.

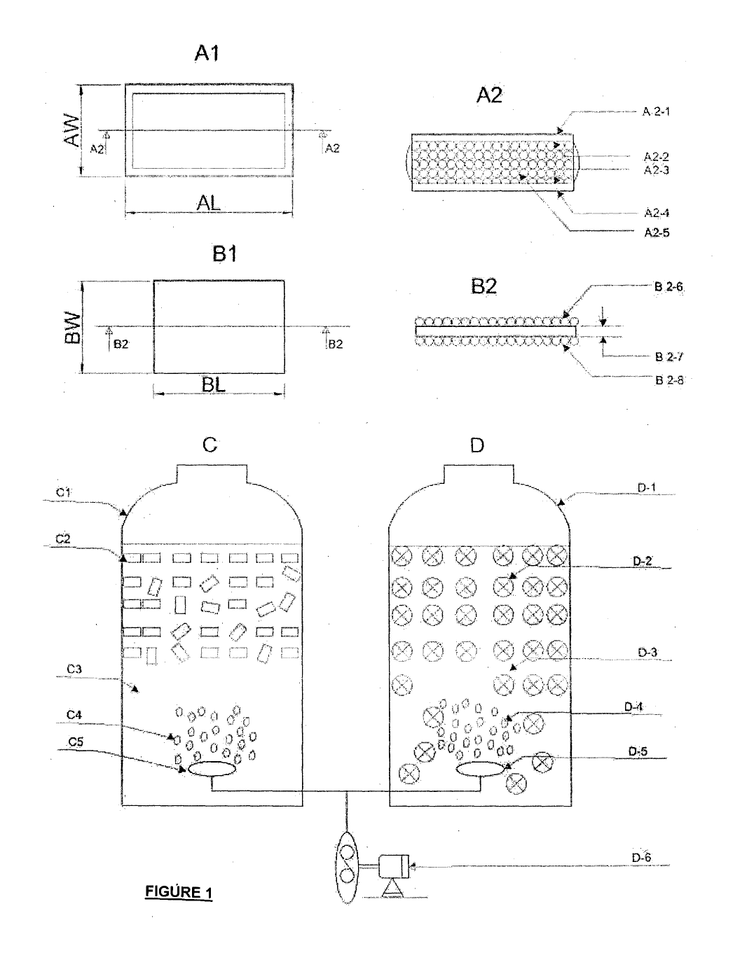

In a further embodiment, sachets of polymer fabric (FIG. 1A) were prepared from various types of polymer fabrics, including shade netting. The shade-netting fabric was seen to be unsuitable since the heat sealing did not last long. The polymer fabric made from closely woven polypropylene fabric such that it would retain within them granules of activated carbon. Preferred colour of the fabric was black, so that the activated carbon trapped within it is not visible as separate powder, which was considered as aesthetically preferred appearance of the sachet. In some embodiments, it was considered desirable that these sachets should also include a float. A float may be made from several materials that have density lesser than water. Such floats include thermocole (a foam-sheet made from polymers and polymer granules that are puffed up) or a polymer foam sheet that does not absorb water, and size of such float was adjusted such that it was possible to make it freely move within the column of the fermenting liquid inside the fermenter when treatment was given to agitate the contents. This embodiment proved to be one of good devices that gave good performance for working of this invention.

An embodiment of this invention comprises use of fixed bed stationary porous media reactor for aerobic treatment of wastewater, wherein the liquid phase is aerated and passed through a fixed bed of porous material. The flow may be from top to bottom or from bottom to top of the fixed bed to the top.

Techno-economic advantages of the instant invention includes, without limitations:
1) Process time reduction
2) Treatment Plant Size reduction—compactness
3) Cost reduction
4) Number of times domestic waste water can be recycled can be increased.
5) The process of this invention would make it possible to install several small decentralized sewage treatment systems, thereby reducing load on a single common sewage treatment facility.

The device of this invention made in the form of sachets/pouches 30×50 mm made from polypropylene cloth and filled with Activated Carbon has following specific advantageous characteristics:
1) Activated carbon can be used without disturbing its original form.
2) The sachets are easy to handle and manufacture
3) Cost of these sachets is comparable with existing MMBR media with added advantage of very high available surface area.
4) The sachets have good mechanical properties enough to withstand the conditions of fermentation, including agitation.
5) Sachets are easily permeable to water/air.
6) Combined surface area for each sachet/pouch is:
   a) Pouch surface area of 30×50 mm—0.006 sq mtr
   b) Activated carbon 1 gram (500 iodine value)—500 sq mtr
   c) Total surface area of one pouch 500.006 sq mtr
   d) Total numbers of pouchs with 2 mm thickness in one cum mtr, volume—3,33,333 nos
   e) Total surface available surface area of only pouch—2000 sq mtr
   f) Total surface area due to activated carbon I gr/pouch—166668666 sq mtr
   g) Total theoretical surface area/cum—combined 166670666 sq mtr
6) Market Available surface area of MMBR media per cum—400 sq mtr.

A person skilled in the art of fermentation will readily realize that although the invention is illustrated for aerobic fermentation for water/sewage/effluent, it can be applied also to anaerobic fermentation, for example of anaerobic fermentation of fruit juice or anaerobic fermentation of sugars for alcohol production; and the same is also included in the scope of this invention.

The invention is illustrated by following non-limiting examples. Any variation that is obvious or is equivalent in view of a person of an ordinary skill in the art are considered to be included within the scope of this disclosure.

### EXAMPLES

Water was purified by reverse osmosis for use in analytical method.

### Example 1

### Determination of COD

COD was determined as per method described in “Standard Methods For The Examination Of Water and Waste Water, 18^{th} Edition, 1992, Edited By Arnold E. Greenberg, Lenore S. Clesceri and Andrew D. Eaton.

In a reflux flask having 0.2 gm Mercuric Sulfate and 0.050 gm of Silver Sulfate, 10 ml of sample for COD determination is added. To this, 2.5 ml of Concentrated Sulfuric Acid are added. Glass beads are added followed by 5 ml potassium dichromate (0.25 N). Further 12.5 ml of Concentrated Sulfuric Acid are slowly added. Mixed well. The flask is now connected to a condenser. The contents are mixed slowly and carefully avoiding bumping. The mixture is refluxed for a minimum of 2 hrs, cooled, and then washed out of condenser with distilled water. The contents are diluted with a minimum of 70 ml cool Distilled Water. Excess potassium dichromate is titrated with 0.25 M ferrous ammonium sulfate using Ferroin indicator. Sharp color change from blue green to red indicates end point of completion of titration. This is designated as reading: B.

A water blank is refluxed in the same manner using Distilled Water. This is designated as reading: A

Calculation: COD=(A−B)×8×1000×0.25/10 mg/liter

### Example 2

### Use of Anthracite and Activated Carbon as Support for Microorganisms

Two round bottom glass flasks having equal volume were used. In each flask, 500 ml each of raw sewage and water was added. In flask No. 1 25 gm of weighed anthracites was added which was previously washed 3-4 times with water and then dried in an oven for one hour for 105 degree. Flask was labeled as “ANTHRACITES”. In Flask. No. 2 25 gm of an Activated Carbon previously was added which was washed 3-4 times with water and dried in an oven for one hour for 105 degree. Aeration was given through pump for 48 hours.

After aeration process, liquid in the flask containing an anthracites liquid appeared turbid and particles were observed to be suspended throughout flask; whereas, the liquid in the flask containing an Activated Carbon was crystal clear and carbon particles completely settled down at the bottom of flask.

After stopping of an aeration process, liquid particles were allowed to settle, and supernatant liquid withdrawn after 1 hr for COD determination for samples drawn from flask containing anthracites and Activated Carbon. COD for flask containing anthracites was 60 mg/liter and the one containing Activated Carbon was 40 mg/liter.

### Example 3

### Determination of COD Value of Sewage Aerobically Treated without or with Activated Carbon, Cultured Activated Carbon, Plastic MBBR Media

Dried activated carbon manufactured by Poornima engg & cabon co was used. Its specifications are: Size 2 to 4 mm, having available surface area approximately 500 to 600 sq meter/grams of carbon.

Cultured Activated Carbon media were prepared by following steps: A proprietary bacterial culture that is commercially used generally in aerobic degradation of sewage was used as bacterial culture for this experiment. The trade name of the product is “EM EFFLU CLEAN”,/Marketed by Energy Equipment (address: 9A, Zackaria Colony Main Road, Choolaimedu, Chennai 600094 Tamil Nadu India Branch Office: 7, West Periyar Pathai, Thirukumarapuram 4th Street, Arumbakkam, Chennai 600 106 Tamil Nadu India). In this place, any bacterial culture that is specifically developed for aerobic degradation of sewage can be used.

In this example:

Untreated sewage at the beginning of the experiment had COD of 280 mg/liter.

1. In flask no. 1, one liter sewage and 10 ml bacterial culture was added.

2. In flask No. 2 one liter sewage, 10 ml of bacterial culture “EM EFFLU CLEAN” and 50 gm of plastic MBBR Media were added.

3. In flask no. 3 one liter sewage, 10 ml bacterial culture “EM EFFLU CLEAN” and 50 gm dried Activated Carbon.

4. In flask No. 4 one liter sewage, 10 ml bacterial culture “EM EFFLU CLEAN” and 50 gm Cultured Activated Carbon media were added. Cultured Activated Carbon media were prepared by inoculating one litre of bacterial culture “EM EFFLU CLEAN” to 18 liters of water containing 1 kg organic jiggery, the mixture covered in a 20 liters bucket in closed condition overnight to activate the bacteria. Activated carbon was added to this activated bacterial culture for 24 hours before use.

Aeration was done in all flasks for 21 days.

At the end of aeration period, COD was determined by method given in Example 1 for contents of all flasks.

For flask 1 COD was 260 mg/liter, for flask 2 COD was 200 mg/liter, for flask 3 COD was 100 mg and for flask 4 COD was 140 mg/liter.

### Example 4

Following are various experiments made for reaching the most preferred embodiment of this invention:
1. Polypropylene granules were melted, activated carbon was added in the molten liquid and a mould was obtained in a ceramic polished saucer. Most of the activated carbon trapped in this mold was not available for providing anchorage to the bacteria. Further, making thin MBBR media of polypropylene impregnated on the surface with activated carbon was not possible with this method. Hence, utility of this method was limited.
2. Activated carbon granules were sprinkled on molten polypropylene granules. Here too a lot of activated carbon was not available for providing anchorage to the bacteria. Here too making thin MBBR media of polypropylene impregnated on the surface with activated carbon was not possible with this method. Hence, utility of this method was limited.
3. Granules of polypropylene were liquefied by melting and the molten polypropylene was poured on activated carbon. The result were similar to (1) and (2) and had same limitations.
4. Activated carbon was placed inside small round containers of polypropylene with holes on the sides. These containers submerged in the fermenter/water tank. Hence, considered not preferred.
5. Activated carbon granules were placed in a tea making plastic sieve that can be immersed in water. These containers also submerged in the fermenter/water tank. Hence, considered not preferred.
6. Activated Carbon granules were inserted between two Tea making plastic sieves mesh which were held together by two curtain rings. These devices did not give satisfactory performance in field trial.
7. Polypropylene foam sheet of thickness 2 mm of sq sheet 50×50 mm was used to stick activated carbon graduals with help of an adhesive. An adhesive that is water insoluble after setting is most preferred adhesive. In the illustrative experiment, a commercially adhesive under brand name “BONDTITE Super Strength” made by Resinova chemi ltd. was used which is described as a general purpose adhesive for several industrial, domestic and construction related applications such as speaker, marble, tile fixing, night bulbs, automotives, bangles, pens etc. It is claimed as an excellent adhesive for pasting Gravel sand over unpolished surface of granite tile to provide grip with cement mortar. The results of field trial using this device were satisfactory.
8. If large scale production of (7) could be arranged, it shall be one viable option on the device of this invention. However, further alternatives were tried.
9. Activated carbon granules, with or without MBBR media available in the market, were filled in a pouch/sachet made from shade-net, a polymer foam sheet of 2 mm having size 50 mm×50 mm was inserted in the sachet and the sachet was heat sealed. However, the heat sealing did not last long and got torn away soon.
10. Sachet made by heat sealing of closely woven nylon fabric with small mesh size was filled with activated carbon and heat sealed. These sachets could not be properly heat sealed. However, if proper sealing could be achieved by some other method, this option may be practical.
11. Sachet was made from polymer cloth used for screen printing, which is closely woven and thick and activated carbon and a polymer foam sheet piece Of 2 mm thick and 50×50 mm size was inserted in it. Activated carbon was clearly visible from outside. This was found to be satisfactory in performance.
12. Sachet/pouch having size 30×50 mm made from polypropylene cloth of was filled with activated carbon and sealed. Cloth of 50-110 gsm was used in illustrative experiments and activated carbon of 1 gram was used. Reasonable variation in size of the sachet, gsm of the fabric and quantity of carbon filed in the pouch can be varied. These sachets gave acceptable performance.

### Example 5

Two plastic tanks/fermenters each of 1 cubic meter capacity were filled up with 1000 liter raw sewage each. To one fermenter (C), 20,000 sachets containing Activated Carbon each were added. The total surface area of all sachets was 120 M² (square meter). The sachets were made from polypropylene woven cloth of 50 gsm (gram per square meter). Quantity of Activated Carbon filled in each sachet was 1 gram. To another fermenter (D), MBBR media available in the market in the form of round plastic discs were added (approximately 36000 in number) such that they provided total surface area of 120 M². Aeration was done continuously with help of blower in both the vessels and allowed to develop culture on pouches and on media. After 15 days, samples of the fermented/treated sewage were drawn and analyzed for BOD by method described in Example 1. C.O.D. Fermented sewage in fermenter (C) was 120 mg/liter; and the one in fermenter (D) was 160 mg/liter.

Thereafter, 300 liters of fermented sewage was withdrawn from each fermenter, was discarded, 300 liter of raw sewage added to each fermenter and the aeration was continued. Raw sewage C.O.D. was 600 mg/Kr.

After 1 hr. and 2 hrs. samples were withdrawn from each fermenter and C.O.D. was determined.

Result: In fermenter C, C.O.D. after 1 hr. was=140 mg/lit, and after 2 hours was=120 mg/lit. In fermenter D after 1 hr was=260 mg/lit, and after 2 hours was=240 mg/lit.

Thus, the sachets of the instant invention exhibited better fermentation efficiency than the prior art MBBR media made from plastic.

1. A method/process of moving bed fermentation of a liquid carried out by microorganisms in a fermenter/Reactor wherein the moving bed comprises a device containing within or on its surface a porous material capable of providing anchorage to bacteria capable of performing fermentation/degradation of organic matter and the device is moveable throughout the column of the liquid in the fermenter/reactor when the device is added to the fermenting liquid and the fermenting liquid is agitated/aerated.

2. The method/process of claim 1 wherein the fermentation comprises aerobic fermentation of water carried out for reducing Chemical Oxygen Demand (COD), the microorganisms comprise any one or more selected from the group consisting of bacteria, fungi and other microorganisms capable of carrying out fermentation and the fermenting liquid is aerated by blower/aerator or by any other means for improving aeration.

3. The method/process of claim 2 comprising the following steps:
a. adding a number of the devices to the water in fermenter/reactor,
b. aerating the water to achieve growth of the microorganisms on the surface of the devices available for anchorage,
c. agitating the liquid in the fermenter by a means for achieving movement of the devices in the fermenter,
d. and allowing the fermentation to proceed for a period of time required to bring down the COD load to 100 ppm (parts per million) or to other target level.

4. The method/process of claim 1 wherein:
a. the fermenting liquid is raw sewage or any other liquid containing fermentable organic dissolved solids,
b. the device comprises a biodegradation resistant Moving Bed Biofilm Reactor Media (MBBR media) or a biodegradation resistant sachet of a fabric permeable to liquid containing dissolved solids containing within it the porous material and, optionally, float that renders the sachet moveable in the fermenting liquid when agitated,
c. the porous material comprises any one or more selected from the group consisting of activated carbon as granules or otherwise, saw dust of wood, chips of wood and diskettes of wood the porous material is activated carbon,
d. the means to provide the agitation/aeration is one or more selected from the group bubbling of air through the fermenter, bubbling oxygen of varying purity thorough the fermenter, using the impeller or propeller, up-flow or down-flow of liquid by pumping action or Twin lobe/centrifugal air blower used to increase dissolved oxygen level.

5. A device containing within or on its surface a porous material capable of providing anchorage to bacteria capable of performing fermentation/degradation of organic matter and the device is moveable throughout the column of the liquid in a fermenter/reactor/aeration tank when the device is added to the fermenting liquid and the fermenting liquid is agitated/aerated.

6. The device of claim 5 wherein the device comprises any one or all of the following:
a. sachets which are made from a material that is permeable to the liquid in the fermenter, hold the porous material within them, and are:
i. made of a material that has a density that helps to make the sachet movable when the sachets are added to the fermenting liquid in fermenter and the fermenting liquid is agitated, or
ii. are associated with a means for adjusting the density of the sachets such that they become moveable when the sachets are added to the fermenting liquid in the fermenter and the fermenting liquid is agitated;
b. an article having surface to which the porous material is immobilized on the surface and the article having a density such that they become moveable when they are added to the fermenting liquid in the fermenter and the fermenting liquid is agitated.

7. The device of claim 6, wherein:
a. in the sub-claim (a) of claim 6, the material that is permeable to the liquid in the fermenter is a fabric/paper made from synthetic polymers or any other material that has reasonably long life and reusability in the fermenter,
b. in the sub-claim a(ii) of claim 6, means for adjusting the density of the sachets comprises a material that has a density lower than water, can be retained within the sachet, and has reasonably long life and reusability in the fermenter,
c. the article in sub-claim (b) of claim 6 comprising any one or more selected from the group consisting of Moving Bed Biofilm Reactor media, and a polymer foam sheet that does not absorb water when immersed in water/fermenting liquid.

8. The device of claim 7 wherein the material that has a density lower than water, can be retained within the sachet, and has reasonably long life and re-usability in the fermenter consists of a synthetic material or a natural material.

9. The device of claim 8 wherein:
a. the synthetic material is one or more selected from the list consisting of any one or more selected from the group comprising a polypropylene foam sheet, plastic media/sheet, polypropylene non woven fabric, polypropylene non woven filter paper, polypropylene woven film/paper/sheet having density lower than water, any colour thickness shape any size and any other synthetic article that can be used as a float.
b. the natural material is one or more selected from the list consisting of painted wood pieces, wood diskettes/small discs, wood chips, wooden filings, perlite, vermiculite or any naturally occurring material that can be used as a float.

10. The device of claim 9 impregnated with live bacteria required for the aerobic fermentation.
